(19) United States
(12) Patent Application Publication
(10) Pub. No.: US 2008/0270937 A1
(43) Pub. Date: Oct. 30, 2008

(54) Control Interface for a Home Automation System and Method for Operating Same

(76) Inventors: Olivier Poulet, Fillinges (FR); Eric Lagarde, Sallanches (FR)

Correspondence Address: FROMMER LAWRENCE & HAUG, 745 FIFTH AVENUE- 10TH FL., NEW YORK, NY, 10151, US

(21) Appl. No.: 11/885,315

(22) PCT Filed: Feb. 27, 2006
(86) PCT No.: PCT/IB2006/000391

§ 371 Date: Apr. 8, 2008

(30) Foreign Application Priority Data
Mar. 1, 2005 (FR) 0502074

(51) Int. Cl. G06F 3/048

(52) U.S. Cl. 715/810

(57) ABSTRACT

The control interface (3) can be used to control a system (1) comprising home automation appliances (2a to 2e). It comprises input keys (8, 9) and an information screen (4) and it is noteworthy in that the screen comprises a main area (5) subdivided into cells (6a, 6b), in each of which a symbol can be displayed, the cells being able to be associated with appliances or with groups of appliances and/or associated with appliance control commands. The invention also relates to methods of operating this interface.

The invention relates to a control interface for controlling a system comprising home automation appliances, the interface comprising input keys and an information screen. It also relates to an operating method, a configuration method and a customization method for such an interface. It also relates to a control method and schedule programming method for a home automation installation using such an interface and an installation comprising home automation appliances and such an interface.

### BACKGROUND OF THE INVENTION

The use of remote control interfaces is known for easily configuring, without wiring or time-consuming configuration, groups of electrical home automation or building automation appliances that can be controlled together from a central or remote control unit.

In theory, each appliance has an individual control interface, wired or otherwise. In addition to this interface, the appliance that is part of a controllable group can therefore be controlled also via a central control unit. In this latter case, the controls intended for each appliance of the group can act either roughly simultaneously, or with time offsets between the executions of the commands.

A group of appliances is not necessarily made up of several appliances. The construction of a group comprising only one appliance makes it possible to have control of that appliance from the central control unit in addition to the individual control interface of that appliance.

The development of home automation applications now makes it possible to control a fairly substantial number of home appliances, in particular shutters, blinds, windows, doors, lighting and domestic electrical appliances.

There is obviously an interest in constructing groups of appliances which correspond to the situation of these appliances relative to the building, for example, all the openings or the shutters of a façade, all the electrical appliances in a room. Once these groups have been constructed, it is then possible to send a common command to the appliances of each of the groups.

It is also useful to provide particular controls appropriate to all kinds of life situations or activities of the occupants of the building such as, in particular, waking up, going to bed, leaving for holiday, leaving for a few hours and afternoon naps. These particular controls, often called scenes or scenarios, are normally linked to groups of appliances and cause the appliances to switch to previously learned configurations.

Because of this, it is necessary to provide means for correctly organizing and naming the groups of appliances to easily find the group to be controlled.

### DESCRIPTION OF THE PRIOR ART

Sophisticated control interfaces are increasingly being seen on the market, the interfaces being of the central control type, provided with liquid crystal screens for displaying a variety of automation-related information such as, in particular, menu options, learning options and individualized icons. The use of a screen obviously makes it possible to display a large quantity of information intended for the user to simplify the control of the home appliances.

Conversely, for reasons of cost, these screens are as often as not of limited size and the information displayed is as often as not displayed via signs or abbreviations. This hampers the correct interpretation of the information by the user.

In the context of controls for groups of appliances, it is commonplace to enable the user to give names to the various groups to find them easily and, if necessary, enable them to be classified. The solutions of the prior art are based, for example, on scrolling lists or drop-down menus, showing the names given to the various groups.

The problem associated with the lists or drop-down menus is as follows: storing and selecting an appliance can be done only by names (in which the number of characters is often limited); displaying a complete list of all the appliances is therefore difficult to achieve, given the small size of the control interface screens, except by considerably reducing the size of the characters, which makes them illegible. These means of organizing and displaying information are therefore not suited to control interfaces having small screens.

U.S. Pat. No. 6,756,998 discloses a home automation appliance control system comprising powerful control tools using a personal computer with a large screen. In this case it is possible to display in graphical form a plan of the home with the locations of the appliances to be controlled in the various rooms. The content of this document is incorporated for reference in this application.

Similarly, this type of solution is not suited to interfaces having small screens.

### SUMMARY OF THE INVENTION

U.S. Pat. No. 5,621,662 discloses a home automation system comprising in particular a user interface that can control one or several home automation appliances. With such a user interface, it is necessary to provide at least as many control keys as there are home automation appliances and appliance operating scenarios. This creates, at the interface level, bulk constraints that very rapidly become unacceptable.

### SUMMARY OF THE INVENTION

The purpose of the invention is to provide a control interface for the control of home automation appliances that makes it possible to improve on the known solutions of the prior art and remedy the abovementioned drawbacks. In particular, the invention proposes a control interface having a small screen suitable for the overall and simplified display of information concerning the home automation appliances that it is used to control and in which the organization of the display can be modified by the user to adapt it to his own home automation system. The invention also proposes an operating method for this control interface and methods of configuring, controlling, schedule-programming and customizing this control interface.

The operating method according to the invention is defined by claim 1.

Various embodiments of this method are defined by the dependent claims 2 to 10.

The control interface according to the invention is defined by claim 11.

Various embodiments of this interface are defined by the dependent claims 12 to 14.

According to the invention, the installation comprises a control interface previously defined and home automation appliances.

### BRIEF DESCRIPTION OF THE DRAWING

The appended drawing shows, by way of example, a home automation installation provided with a control interface according to the invention and various procedures for operating such a control interface.

FIG. 1 is a diagram of a home automation installation comprising a control interface according to the invention.

FIG. 2 is a diagram of a control interface according to the invention.

FIG. 3 is a diagram representing the operation of the control interface when it is in a configuration mode.

FIG. 4 is a diagram representing the operation of the control interface when it is in a control mode.

FIG. 5 is a diagram representing the operation of the control interface when it is in a customization mode.

### DESCRIPTION OF THE PREFERRED EMBODIMENTS

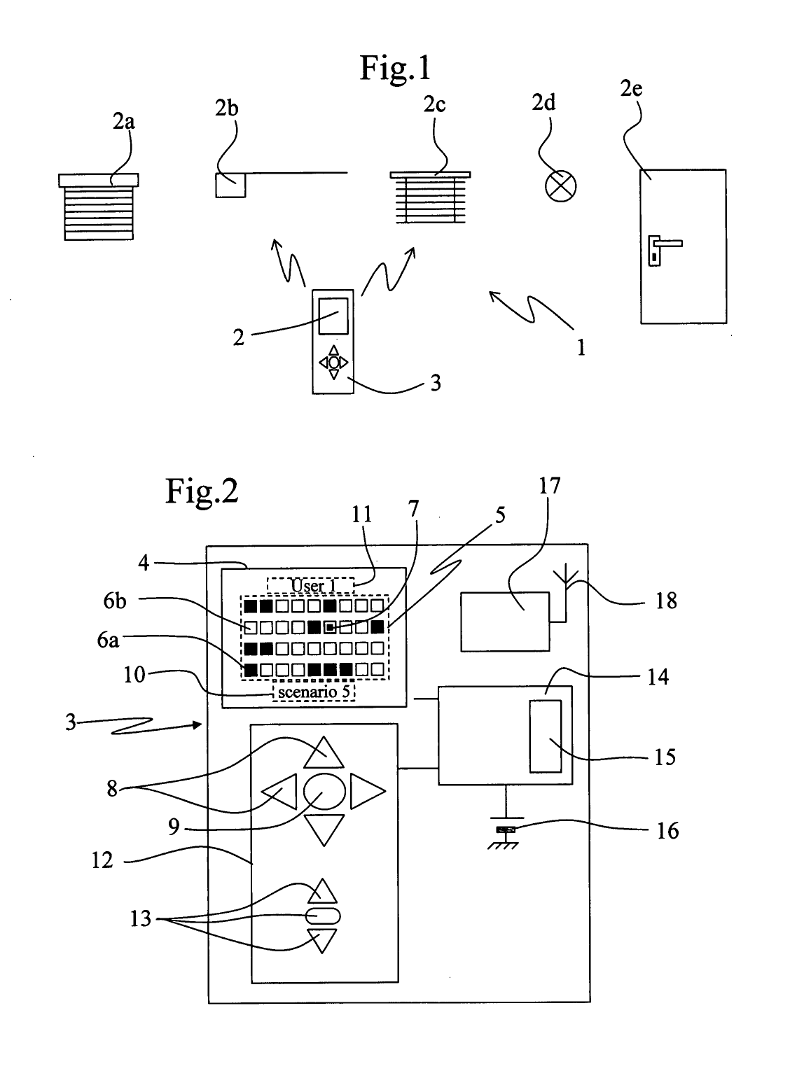

The home automation installation 1 represented in FIG. 1 mainly comprises home automation appliances 2a to 2e such as, in particular, a rolling shutter 2a, a garage door actuator 2b, a blind 2c, a lighting device 2d and a door 2e. It also comprises a control interface 3 intended for the control of these home automation appliances. This control can preferably be conducted by the transmission of control commands in the form of radiofrequency waves.

### Control Interface:

The control interface 3 represented in FIG. 2 comprises a processing logic unit 14 (such as a microcontroller) electrically linked to a keyboard 12, to a display screen 4 and to means 17, 18 of sending and receiving radiofrequency waves. The control interface 3 is powered by a battery 16. The keyboard 12 and the display screen form the user interface 3a of the control interface 3.

The processing logic unit 14 comprises a memory 15 for storing configuration information concerning the control interface and information relating to the appliances controlled by the control interface such as, for example, their identifiers and the commands that can be executed. This memory can also be used to store software modules determining the operation of the interface.

The means of sending and receiving radiofrequency waves comprise a modulator/demodulator circuit 17 and an antenna 18. The various appliances 2a to 2e are also equipped with means of sending and receiving radiofrequency waves (not shown).

The keyboard 12 comprises control keys 13. In certain operating modes, pressing on these keys causes control commands that are associated with them to be sent. The keyboard 12 also comprises navigation keys 8 and a validation key 9, the functions of which are described below.

The display screen 4 displays a main area 5 subdivided into cells 6a, 6b. Preferably, the screen is rectangular and the cells are square. Preferably, the cells all have the same dimensions. The dimensions of the cells are preferably less than 5 mm. The various cells are also preferably organized in rows and columns to form a matrix. In each of the cells, one or more symbols can be displayed. These symbols can, in particular, consist of geometric shapes such as squares, circles, disks or triangles. One or more auxiliary areas 10, 11 intended for the display of information in the form of alphanumeric character strings are also provided, for example on either side of the main area.

The screen is preferably of liquid crystal or plasma photo-emissive, or organic diode type. It can also be of tactile type. In this case, all or part of the keyboard 12 described previously can be incorporated in the screen so that a pressure on a particular area of the screen has the same function as a keystroke. Furthermore, input means other than keys can be used. These control means can, in particular, comprise thumbwheels or trackballs.

The cells can be associated:
with a home automation appliance, or
with a group of home automation appliances, or
with a control command, or
with a home automation appliance and with a control command (that is, a control command addressed to a home automation appliance), or
with home automation appliances and control commands (that is, control commands addressed to home automation appliances).

A cell associated with one or more elements described previously is said to be “assigned”, an unassociated cell is said to be “unassigned”.

The effects of these associations are explained below.

A cursor 7 can also be displayed and moved on the screen in the main area to be brought to a required cell. This cursor can also be moved from the main area to the auxiliary areas. It is moved by pressing the navigation keys 8 on the keyboard. The cursor can, for example, take the form of a display reversal, a highlight, an outline, blinking or a change of color.

The symbols displayed in the cells can have various meanings. For example, the presence of a symbol, of whatever kind, means that the cell is “assigned”. Depending on the capabilities offered by the screen and the processing logic unit, the provision of different symbols can be envisaged. It is then possible to have different types of symbols indicating the state of the associated appliance or appliances, for example, a white square for open rolling shutters or lamps that are on and a black square for closed rolling shutters or lamps that are off. Alternatively, different colors can be used to indicate states or, where appropriate, assist with memorizing by using color codes for different control types (appliance on its own, group, scenario) or different spaces in the home (lounge, bedrooms, garden).

The organization of the main area of the screen in matrix form makes it possible to organize the “assigned” cells according to:
a spatial representation corresponding to the positions of the appliances in the building, or
a mental or mnemotechnical representation, or
an alphabetic organization, or
a chronological organization, or
any other organization defined or desired by the user.

### Method of Operating the Control Unit:

The control interface 3 can operate in various modes, in particular:
a user mode, or control mode, in which the home automation appliances associated with cells represented on the screen can be controlled from the control interface;
a configuration mode, which can be used to store associations between cells and appliances and/or control commands;
a customization mode, in which it is possible to reorganize the cells and, where appropriate, the so-called “assigned” cells, within the main area.

The method can also include a schedule programming mode in which it is possible to organize the placement of cells associated with at least one appliance and with at least one control command so as to program the sending of control commands at predetermined dates.

In the different operating modes, the functionalities of the user interface 3a, comprising mainly the screen 4 and the keyboard 12, will enable the user to select cells or the symbols contained in these cells, move them to other cells to reorganize the display in the main area of the screen. These various operations can be seen by the user through the use of a cursor.

The validation or input keys of the user interface can be used to move the cursor and select, for example within a temporary memory, the content of the cell on which the cursor is positioned.

The movement of the cursor from one cell to another automatically results in a change to the display, in an auxiliary area of the screen, of a name that may be given to the cell and correspond to its assignment.

The operating mode can be chosen by selection in a menu displayed on the screen. In each mode the matrix of cells and any information on the auxiliary areas will then be displayed.

The display is therefore similar in the different operating modes.

If necessary, an indicator can be used to identify the operating mode (for example, in the form of a pictogram or an initial letter in an auxiliary area).

### Method of Configuring the Control Interface:

Once in the configuration mode, the configuration method makes it possible to define the associations between the cells, the home automation appliances and the control commands concerning these appliances.

In a phase prior to the configuration of the control interface, it is assumed that, via learning procedures known from the prior art, the control interface has received and stored in memory a certain quantity of information relating to the home automation appliances that it has to control. This information comprises in particular the identifiers of the appliances and the nature of the commands that can be executed by these appliances.

Alternatively, this learning may take place during the control interface configuration procedure.

The information exchanged during this learning procedure can also be stored, or partially stored, on the home automation appliances.

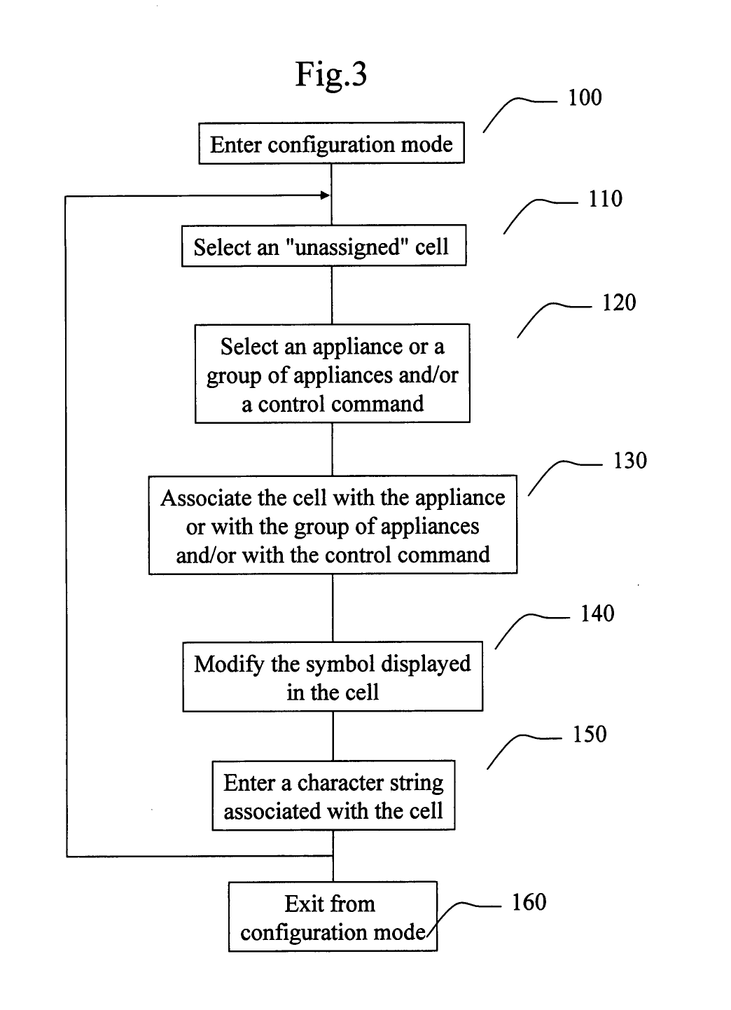

One embodiment of a configuration method is described below, by way of example, with reference to FIG. 3. Configuring is done by an installer.

In a first step 100, a succession or combination of particular keystrokes on the keyboard 12 of the control interface 3 switches it to configuration mode. Entry into the configuration mode can also be obtained via a menu option, displayed on the screen.

In a second step 110, the installer moves the cursor 7 over the screen so as to position it on a so-called “unassigned” cell. The installer then presses the validation key 9 and the cell is then selected.

In a step 120, an appliance or group of appliances is selected. This step can be performed in several ways, the examples given below not being limiting.

According to a first possibility, the identifiers of the appliances that can be controlled by the control interface are displayed in the auxiliary areas of the screen. They can be made to scroll by pressing the navigation keys. Similarly, the names of the control commands that can be executed by the appliances are displayed in the auxiliary areas of the screen. By pressing the validation key when these identifiers and/or these commands appear in the auxiliary areas, the installer selects the appliances and/or the control commands.

According to another configuration possibility, the appliances are selected by acting on them (for example, by sending an command using an individual control appliance such as a handheld remote control), and this action causes a message to be sent identifying the appliance and, where appropriate, the command. The information contained in this message is then stored on the control interface. The operation is repeated for the various appliances that must be associated with one and the same cell, before validating the records and therefore the assignment of the cell.

In a step 130, following a validation action, the appliances and/or the control commands selected are associated with the selected cell.

For this, the identifiers of the appliances and/or of the control commands are, for example, stored in a memory area 15, this area having been previously associated with the selected cell.

Conversely, an identifier corresponding to the selected cell can be stored on the appliances.

Another possible way of carrying out the steps 120 and 130 consists in storing, at the various appliances associated with a cell, an identifier of that cell. An appliance (or several appliances) being first of all placed in a programming mode (by a particular action on this appliance for example), it then receives a message from the control interface informing it that it is associated with a given cell. In a simple way, the control message including this information is an identification code comprising the number of the cell. The message is broadcast to all the appliances, but only the appliance set to a programming mode uses this information.

The appliance stores information in an appropriate memory so that, when this cell is selected in a control mode, it interprets the corresponding command as being addressed to it. Several appliances can thus be programmed simultaneously to be associated with a given cell.

In a step 140, the display of the cell is automatically altered so as to show its “assigned” state. For example, if the cell is symbolized as free when it is “unassigned”, a square can replace this symbol when it is “assigned”.

In a step 150, an alphanumeric character string can be entered to be associated with the “assigned” cell. This string can, for example, consist of “blind” when the cell is associated with a blind, “raise” when it is associated with a raise command or “raise blinds” when it is associated with a raise command related to multiple blinds.

The method can loop to the step 110 when different cells have to be associated with different elements.

In a step 160, a succession or combination of particular keystrokes on the keyboard 12 of the control interface can be used to switch it out of the configuration mode.

### Control Method:

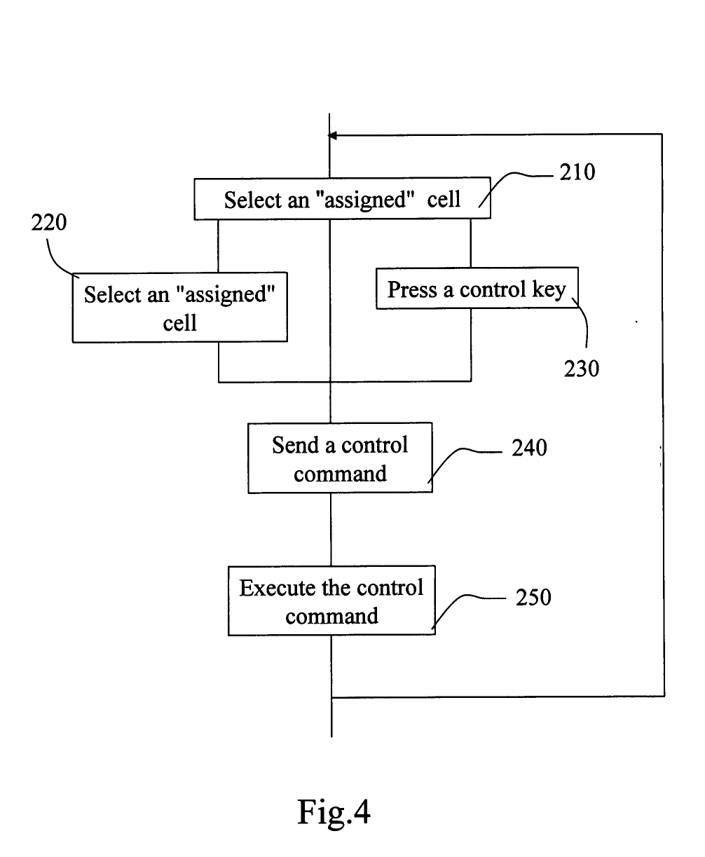

One way of executing a control method is described below, as an example, with reference to FIG. 4. The control method is implemented once the interface is in the user mode.

It is assumed that the control interface defaults to the user mode.

In a first step 210, a user moves a cursor 7 on the screen so as to position it on a so-called “assigned” cell associated with an appliance or a group of appliances that he wants to control. The user then presses the validation key 9 and the cell is then selected.

If the first selected cell is associated with only one appliance or only one group of appliances, the user can:
either, in a first step 220, move a cursor 7 over the screen so as to position it on a second so-called “assigned” cell associated with one or more control commands that he wants executed on the appliance or appliances. In this case, the user then presses the validation key 9 and the second cell is then selected.
or, in a step 230, press a control key on the keyboard corresponding to the control command that he wants executed by the appliance or appliances.

In these cases, in a step 240, the control command or commands is/are directly transmitted to the appliance or appliances.

If the first selected cell is associated with an appliance or a group of appliances and with a control command or several control commands, the method goes directly to the step 240, in which the control command or commands are directly transmitted to the appliance or appliances.

In a step 250, the control command or commands is/are executed by the appliance or appliances.

The method then loops to the step 210.

By moving the cursor to an “assigned” cell, the user can view the list of elements with which it is associated, these being displayed in the auxiliary areas.

### Method of Customizing the Control Interface:

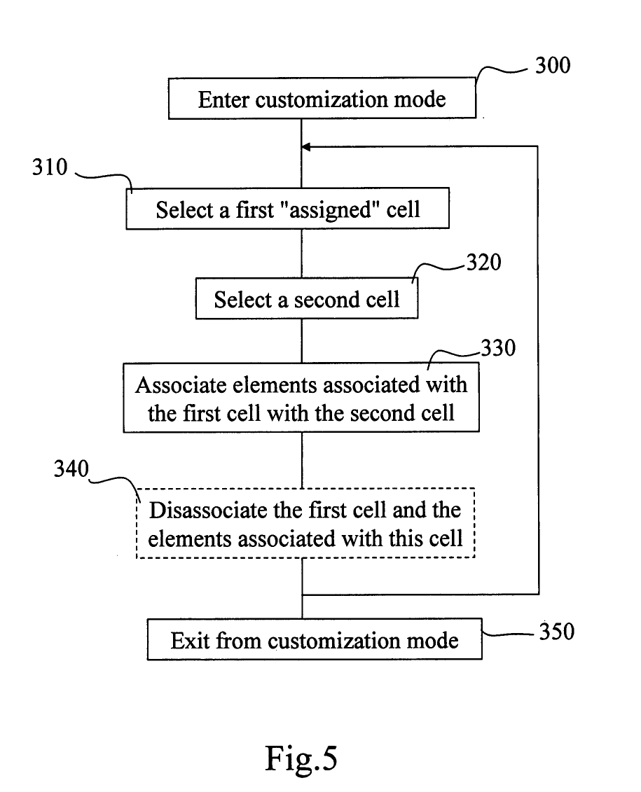

Once in the customization mode, the customization method is implemented. One way of executing a customization method is described below, as an example, with reference to FIG. 5. This customization mode is particularly useful for adapting the spatial representation of the cells and/or of the symbols relating to the various states of the cells to the user's preferred representation, or to that which is easiest to memorize. The customization mode also makes it possible to construct time-oriented sequences of scenarios.

In a first step 300, a succession or combination of particular keystrokes on the keyboard 12 of the control interface can be used to switch it to the customization mode.

The customization mode can also be accessed through a menu option displayed on screen.

In a second step 310, the user moves the cursor 7 over the screen so as to position it on a first “assigned” cell whose position he wants to modify in the main area. The user then presses the validation key 9 and the cell is then selected.

In a third step 320, the user moves the cursor 7 over the screen so as to position it on a second cell that he wants to associate with the elements with which the first cell is for the moment associated. The user then presses the validation key 9 and the second cell is then selected.

In a fourth step 330, the elements associated with the first cell are automatically associated with the second cell. In the case where the second cell is already assigned to elements, these elements are disassociated from the second cell and can be associated with a third cell after selecting said cell.

In an optional step 340, the elements associated with the first cell are disassociated from the latter. If this step is not implemented, the second cell is a simple copy of the first. This step can take place between the steps 310 and 320. The information is then stored in a temporary memory.

The selection of the first selected cell can be marked visibly to the user, for example by having the cell blink until it is reassigned to a new position.

The method then loops to the step 310 until, in a step 160, a succession or combination of particular keystrokes on the keyboard 12 of the control interface enables it to be switched out of the customization mode.

In the customization mode, it is also possible in the step 310 to modify the symbol or the color used to represent the selected cell. The various symbols and colors are scrolled, for example, by a prolonged press on the validation key 9.

The invention in particular makes it possible to easily configure and execute appliance control scenarios. A scenario can, for example, correspond to a series of different control commands executed by different appliances. Thus, for example, when leaving the building for a long period, it is useful to close all the shutters, lock all the doors and switch off the lights. With the invention to define such a scenario, one and the same cell has associated with it all the shutters, all the doors and all the lights, as well as an command to lower the shutters, an command to lock the doors and an command to switch off the lights. To execute the scenario, all that is then needed is to move the cursor over the cell concerned and select it. The lowering command is automatically sent to the shutters, the locking command is automatically sent to the doors and the switch-off command is automatically sent to the lights.

### Method of Programming Schedules and Automatic Control Method:

The invention also makes it possible to simply and visually create a succession of scenarios in a given time period. To this end, at least one row of cells on the matrix screen is assigned to a time representation, for example, the bottom row of cells on the screen. The cells associated simultaneously with a control command or control commands concerning an appliance or several appliances are selected and duplicated according to the method described in FIG. 5, the duplication occurring towards the bottom line. This bottom line then constitutes a time line. The succession of the cells is representative of the time-oriented sequencing of the scenarios.

The time line is advantageously separate from the other rows of cells. Alternatively, the symbol associated with a cell changes type immediately when this cell is duplicated in the time line.

When a cell is then selected on the time line, the navigation keys can be used to modify a scenario activation time, displayed on the alphanumeric part of the screen. An “empty” cell between two cells positioned on the time line represents a conditional test relating to the running of the next cell's scenario. When such a cell is selected, the navigation keys can be used to select the conditions for switching to the next cell.

If the time line comprises 24 cell positions, or a multiple of this number, a simple variant consists in assigning each position one hour of the day. The duplication of a cell in one of these locations is then sufficient to indicate the time at which the associated scenario must be triggered.

To implement this schedule programming method, it is necessary to switch the control interface to a schedule programming mode.

A more sophisticated variant consists in changing the nature of the display between the step 310 and the step 320. In the step 310, the display is that of the assigned cells, some cells therefore being simultaneously assigned to an appliance and a control. Immediately one of these cells is selected, the method switches to the step 320 in which the screen displays seven rows of cells, each comprising 24 positions. The selection of one (or more) of these cells to duplicate therein the selected cell (attached to the cursor) makes a weekly programming possible.

As has been seen in the course of this description, the input means are not associated individually with the different cells on the screen. In practice, the input means are common to the cells. In other words, the input means can act on at least several cells on the screen. Thus, for example, the keys 8 can be used to move a cursor to any one of the cells on the screen, the key 9 can be used to validate the selection of any one of the cells on the screen and the keys 13 can be used to individually control the movements of any one of the moving elements of the home automation appliances which are associated with one of the cells on the screen, once this cell is selected.

1. A method of operating a control interface for the control of a system comprising home automation appliances, the interface comprising input means and an information screen, the screen comprising a main area subdivided into cells, in each of which a symbol can be displayed, at least some so-called “assigned” cells being associated with appliances or with groups of appliances and/or associated with appliance control commands, a so-called “unassigned” cell not being associated, the method presenting:
a mode of use intended for the control of the home automation appliances of the system, including a step for selecting a cell comprising moving a cursor over the screen to position it on a so-called “assigned” cell associated with an appliance or with a group of appliances to be controlled,
a configuration mode for storing associations between cells and appliances or groups of appliances and/or appliance control commands.

2. The operating method as claimed in claim 1, wherein the movement of the cursor is controlled by actions on input means of the control interface.

3. The operating method as claimed in claim 1, wherein the step for selecting a cell also comprises a validation phase comprising an action on an input means of the control interface.

4. The operating method as claimed in claim 1, which, in the configuration mode, presents at least the following steps:
selection of an “unassigned” cell,
selection of an appliance or a group of appliances and/or one or more control commands,
validation associating the previously selected cell with the appliance or with the group of appliances and/or with the control command or commands previously selected.

5. The operating method as claimed in claim 1, which comprises a customization mode intended for spatially organizing, in the main area of the screen, the cells associated with appliances or with groups of appliances and/or associated with appliance control commands.

6. The operating method as claimed in claim 5, which, in the customization mode, presents at least the following steps:
selection of a first cell, this cell being assigned,
selection of a second cell, resulting in the association of the second cell with the appliance or with the group of appliances and/or with the control command or commands previously associated with the first cell.

7. The operating method as claimed in claim 6, wherein, in the customization mode, the selection of the second cell results in the disassociation between:
the first cell, and
the appliance or the group of appliances and/or the control command or commands.

8. The operating method as claimed in claim 1, wherein, in the user mode, the nature and the destination of the control command sent are at least partially determined by the selection of the cell or cells and/or by the action on an input means.

9. The operating method as claimed in claim 8, which, in the user mode, comprises selecting two assigned cells, a first cell determining the nature of the control command to be transmitted and a second cell determining the destination of the control command to be transmitted.

10. The operating method as claimed in claim 1, which comprises a schedule programming mode for programming the automatic sending of control commands to appliances at predetermined times and which, in this schedule programming mode, comprises the following steps:
selection of a first cell, this cell being associated with at least one control command and at least one appliance,
selection of a second cell forming part of a spatial succession of cells corresponding to a temporal succession of dates, the selection of this second cell resulting in the association of the second cell with the appliances and control commands associated with the first cell.

11. A control interface for controlling a system comprising home automation appliances, the interface comprising input means and an information screens, wherein the screen comprises a main area subdivided into cells, in each of which a symbol can be displayed, the cells being able to be associated with appliances or with groups of appliances and/or associated with appliance control commands, said interface also comprising hardware means and software means for implementing the operating method as claimed in claim 1.

12. The control interface as claimed in claim 11, wherein the screen comprises at least one auxiliary area for displaying alphanumeric character strings.

13. The control interface as claimed in claim 11, wherein, at least in a schedule programming mode, at least one spatial succession of cells corresponds to a temporal succession of dates.

14. The control interface as claimed in claim 11, wherein the input means are input keys.

15. An installations comprising a control interfaces as claimed in claim 11 and home automation appliances.
